(19) United States
(12) Patent Application Publication
(10) Pub. No.: US 2022/0143470 A1
(43) Pub. Date: May 12, 2022

(54) MULTI-LAYERED GOLF BALLS HAVING INNER CORES WITH LARGE DIAMETERS

(71) Applicant: Acushnet Company, Fairhaven, MA (US)

(72) Inventor: Manjari Kuntimaddi, Raynham, MA (US)

(73) Assignee: Acushnet Company, Fairhaven, MA (US)

(21) Appl. No.: 17/500,208

(22) Filed: Oct. 13, 2021

Related U.S. Application Data
(60) Provisional application No. 63/112,734, filed on Nov. 12, 2020.

(51) Int. Cl. A63B 37/00

(52) U.S. Cl. CPC A63B 37/0064; A63B 37/0051; A63B 37/0024; A63B 37/0092; A63B 37/0063; A63B 37/0065

(57) ABSTRACT

Multi-layered golf balls having an inner core with a relatively large diameter are provided. In one embodiment, the golf ball comprises an inner core, outer core, and cover. The inner core comprises a thermoset or thermoplastic composition. For example, a blend of polybutadiene rubbers can be used to form the inner core. The outer core layer is relatively thin and comprises a thermoset or thermoplastic composition. The dimensions and compressions of the core layers have specific relationships referred to as the Core Profile. The golf ball further comprises a cover having at least one layer. Ethylene acid copolymer ionomers and polyurethanes, particularly thermoplastic polyurethane, can be used to form the cover.

### CROSS-REFERENCE TO RELATED APPLICATIONS

This application claims the benefit of U.S. Provisional Application No. 63/112,734, filed Nov. 12, 2020, the entire disclosure of which is hereby incorporated herein by reference.

### BACKGROUND OF THE INVENTION

### Field of the Invention

The present invention relates generally to multi-piece golf balls comprising a core having at least one layer and a cover having at least one layer. The inner core layer preferably comprises a thermoset or thermoplastic composition and has a relatively large diameter. The outer core layer preferably comprises a thermoset or thermoplastic composition and has a relatively small diameter.

### Brief Review of the Related Art

Both professional and amateur golfers use multi-piece, solid golf balls today. Basically, a two-piece solid golf ball includes a solid inner core protected by an outer cover. The inner core is made of a natural or synthetic rubber such as polybutadiene, styrene butadiene, or polyisoprene. The cover surrounds the inner core and may be made of a variety of materials including ethylene acid copolymer ionomers, polyamides, polyesters, polyurethanes, and polyureas.

In recent years, three-piece, four-piece, and even five-piece balls have become more popular. These multi-piece balls have become more popular for several reasons including new manufacturing technologies, lower material costs, and desirable ball playing performance properties. Many golf balls used today have multi-layered cores comprising an inner core and at least one surrounding outer core layer. For example, the inner core may be made of a relatively soft and resilient material, while the outer core may be made of a harder and more rigid material. The “dual-core” sub-assembly is encapsulated by a single or multi-layered cover to provide a final ball assembly. Different materials can be used to manufacture the core and cover and impart desirable properties to the finished ball.

In general, dual-cores comprising an inner core (or center) and a surrounding outer core layer are known in the industry. For example, Sugimoto, U.S. Pat. No. 6,390,935 discloses a three-piece golf ball comprising a core having a center and outer shell and a cover disposed about the core. The specific gravity of the outer shell is greater than the specific gravity of the center. The center has JIS-C hardness (X) at the center point and JIS-C hardness (Y) at a surface point satisfying the equation: (Y−X)≥8. The core structure (center and outer shell) has JIS-C hardness (Z) at a surface of 80 or greater. The cover has a Shore D hardness of less than 60.

Endo, U.S. Pat. No. 6,520,872 discloses a three-piece golf ball comprising a center, an intermediate layer formed over the center, and a cover formed over the intermediate layer. The center is preferably made of high-cis polybutadiene rubber; and the intermediate and cover layers are preferably made of an ionomer resin such as an ethylene acid copolymer.

Watanabe, U.S. Pat. No. 7,160,208 discloses a three-piece golf ball comprising a rubber-based inner core; a rubber-based outer core layer; and a polyurethane elastomer-based cover. The inner core layer has JIS-C hardness of 50 to 85; the outer core layer has JIS-C hardness of 70 to 90; and the cover has Shore D hardness of 46 to 55. Also, the inner core has a specific gravity of more than 1.0, and the core outer layer has a specific gravity equal to or greater than that of that of the inner core.

The core structure as an engine or spring for the golf ball. Thus, the composition and construction of the core is a key factor in determining the resiliency and rebounding performance of the ball. In general, the rebounding performance of the ball is determined by calculating its initial velocity after being struck by the face of the golf club and its outgoing velocity after making impact with a hard surface. More particularly, the “Coefficient of Restitution” or “COR” of a golf ball refers to the ratio of a ball's rebound velocity to its initial incoming velocity when the ball is fired from an air cannon into a rigid vertical plate. The COR for a golf ball is written as a decimal value between zero and one. A golf ball may have different COR values at different initial velocities. The United States Golf Association (USGA) sets limits on the initial velocity of the ball so one objective of golf ball manufacturers is to maximize COR under such conditions. Balls with a higher rebound velocity have a higher COR value. Such golf balls rebound faster, retain more total energy when struck with a club, and have longer flight distance as opposed to balls with low COR values. These properties are particularly important for long distance shots. For example, balls having high resiliency and COR values tend to travel a far distance when struck by a driver club from a tee.

The durability, spin rate, and feel of the ball also are important properties. In general, the durability of the ball refers to the impact-resistance of the ball. Balls having low durability appear worn and damaged even when such balls are used only for brief time periods. In some instances, the cover may be cracked or torn. The spin rate refers to the ball's rate of rotation after it is hit by a club. Balls having a relatively high spin rate are advantageous for short distance shots made with irons and wedges. Professional and highly skilled amateur golfers can place a back spin more easily on such balls. This helps a player better control the ball and improves shot accuracy and placement. By placing the right amount of spin on the ball, the player can get the ball to stop precisely on the green or place a fade on the ball during approach shots. On the other hand, recreational players who cannot intentionally control the spin of the ball when hitting it with a club are less likely to use high spin balls. For such players, the ball can spin sideways more easily and drift far-off the course, especially if it is hooked or sliced. Meanwhile, the “feel” of the ball generally refers to the sensation that a player experiences when striking the ball with the club and it is a difficult property to quantify. Most players prefer balls having a soft feel, because the player experience a more natural and comfortable sensation when their club face makes contact with these balls. Balls having a softer feel are particularly desirable when making short shots around the green, because the player senses more with such balls. The feel of the ball primarily depends upon the hardness and compression of the ball.

Manufacturers of golf balls are constantly looking to different materials for improving the playing performance and other properties of the ball. The present invention provides golf balls having advantageous properties and features.

### SUMMARY OF THE INVENTION

The present invention generally relates to multi-layered golf balls and more particularly to golf balls comprising an inner core having a relatively large diameter. In one embodiment, the golf ball comprises a core assembly and a cover having at least one layer. The core assembly comprises: a) an inner core comprising a thermoset or thermoplastic composition; the inner core having an inner core diameter (ICD) in the range of about 1.2 to about 1.5 inches and an outer surface hardness (H_{inner core surface}), a center hardness (H_{inner core center}), an inner core volume (ICV), and an inner core compression (ICC); and b) an outer core layer comprising a thermoset or thermoplastic composition, the outer core layer being disposed about the inner core and having a thickness in the range of about 0.05 to about 0.2 inches such that the total core assembly has a total core diameter (TCD) of between about 1.5 to about 1.6 inches, the outer core having an outer surface hardness (H_{outer surface of OC}), a midpoint hardness (H_{midpoint of OC}), an outer core volume (OCV), and a total core compression (TCC), wherein ICV is greater than OCV and the core assembly has a Core Profile of about 1.8 or greater, wherein:

$$\frac{Inner Core Diameter}{Total Core Diameter} \times \frac{Total Core Compression}{Inner Core Compression} = Core Profile .$$

In one embodiment, the Core Profile is greater than 2.0; and in another embodiment, the Core Profile is greater than 3.0. The OCV can have a value less than or equal to the value, X, calculated according to the Equation: (0.9)(ICV)=X. The TCC can have a value greater than or equal to the value, Y, calculated according to the Equation: (2.0)(ICC)=Y.

The inner and outer core layers can comprise a thermoset rubber composition, wherein the rubber is selected from the group consisting of polybutadiene, polyisoprene, ethylene-propylene, ethylene-propylene-diene, styrene-butadiene, and, polyalkenamer rubbers, and mixtures thereof. Preferably, a blend of polybutadiene rubbers is used to form the inner core.

In one embodiment, the H_{inner core surface} is greater than the H_{inner core center} to provide a positive hardness gradient across the inner core; and the H_{outer surface of OC} is greater than the H_{midpoint of OC} to provide a positive hardness gradient across the outer core. In one embodiment, the H_{outer surface of OC} is greater than the H_{inner core center} to provide a positive hardness gradient across the total core assembly. The positive hardness gradient across the total core assembly can be in the range of about 15 to about 30. In one embodiment, the inner core comprises at least about 60% of the total volume of the total core assembly. In another embodiment, the inner core comprises at least about 70% of the total volume of the total core assembly. In one embodiment, the inner core has a diameter of about 1.39 inches and the total core assembly has a diameter of about 1.55 inches. In another embodiment, the inner core has a diameter of about 1.25 inches and the total core assembly has a diameter of about 1.55 inches. In one embodiment, the inner core has a compression in the range of about 20 to about 50 and the total core assembly has a compression in the range of about 60 to about 110.

In one embodiment, the cover is single-layered and comprises an ethylene acid copolymer containing acid groups such that less than 70% of the acid groups are neutralized. For example, the cover can comprise a blend of a sodium neutralized ethylene acid copolymer and a lithium neutralized ethylene acid copolymer. In another embodiment, the cover has an inner cover layer and an outer cover layer; and the inner cover layer comprises an ethylene acid copolymer containing acid groups such that less than 70% of the acid groups are neutralized; and the outer cover layer comprises a polymer selected from the group consisting of polyurethanes, polyureas, polyurethane-urea hybrids, and copolymers and blends thereof. Preferably, the outer cover layer comprises a thermoplastic or thermoset polyurethane composition.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a cross-sectional view of a core assembly for a golf ball made in accordance with the present invention;

FIG. 2 is a cross-sectional view of a three-piece golf ball having a two-layered core assembly and a single-layered cover made in accordance with the present invention;

FIG. 3 is a cross-sectional view of a four-piece golf ball having a two-layered core assembly and a two-layered cover made in accordance with the present invention; and

FIG. 4 is a perspective view of a dimpled golf ball made in accordance with the present invention.

### DETAILED DESCRIPTION OF THE INVENTION

Golf balls having various constructions may be made in accordance with this invention. For example, golf balls having two-piece, three-piece, and four-piece constructions with single or multi-layered cover materials may be made. Representative illustrations of such golf ball constructions are provided and discussed further below. The term, “layer” as used herein means generally any spherical portion of the golf ball. More particularly, in one version, a two-piece golf ball containing a core with a surrounding cover is made. Three-piece golf balls containing a dual-layered core and single-layered cover also can be made. The dual-core includes an inner core (center) and surrounding outer core layer. In another version, a four-piece golf ball containing a dual-core and dual-cover (inner cover and outer cover layers) is made. In yet another construction, a four-piece or five-piece golf ball containing a dual-core; casing layer(s); and cover layer(s) may be made. As used herein, the term, “casing layer” means a layer of the ball disposed between the multi-layered core assembly and cover. The casing layer also may be referred to as a mantle or intermediate layer. The diameter and thickness of the different layers along with properties such as hardness and compression may vary depending upon the construction and desired playing performance properties of the golf ball as discussed further below.

Core Structure

The golf ball may contain a single- or multi-layered core. In one preferred embodiment, a core assembly comprising an inner core (center) and surrounding outer core layer is made. Thermoset or thermoplastic compositions may be used to form the inner core and outer core layers. In one preferred embodiment, at least one of the core layers is formed from a rubber composition. Preferably, the rubber composition comprises polybutadiene rubber. More particularly, in one version, the ball contains a dual-core comprising an inner core (center) and surrounding outer core layer, each layer made of a polybutadiene rubber composition.

Suitable rubber compositions for forming at least one of the core layers include, but are not limited to, rubber compositions comprising a rubber material such as, for example, polybutadiene, ethylene-propylene rubber, ethylene-propylene-diene rubber, polyisoprene, styrene-butadiene rubber, polyalkenamers, butyl rubber, halobutyl rubber, or polystyrene elastomers. For example, thermoset rubber compositions containing polybutadiene rubber may be used to form both the inner core (center) and surrounding outer core layer in a dual-layered construction. In another version, at least one of the core layers is formed from a thermoplastic composition. For example, ionomer compositions comprising an ethylene acid copolymer containing acid groups such that less than 70% of the acid groups are neutralized (partially neutralized polymers) may be used. In another example, ionomer compositions comprising an ethylene acid copolymer containing acid groups such that greater than 70% of the acid groups are neutralized (highly neutralized polymers or HNPs) may be used. For example, thermoplastic ionomer compositions may be used to form both the inner core (center) and surrounding outer core layer in a dual-layered construction. In another example, a thermoset rubber composition may be used to form the inner core and a thermoplastic ionomer composition may be used to form the outer core. In yet another example, a thermoplastic ionomer composition may be used to form the inner core and a thermoset rubber composition may be used to form the outer core layer. Such rubber and ionomer compositions are discussed in further detail below.

In general, polybutadiene is a homopolymer of 1, 3-butadiene. The double bonds in the 1, 3-butadiene monomer are attacked by catalysts to grow the polymer chain and form a polybutadiene polymer having a desired molecular weight. Any suitable catalyst may be used to synthesize the polybutadiene rubber depending upon the desired properties. Normally, a transition metal complex (for example, neodymium, nickel, or cobalt) or an alkyl metal such as alkyllithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. A preferred polybutadiene rubber has a 1,4 cis-bond content of at least 40%, preferably greater than 80%, and more preferably greater than 90%. In general, polybutadiene rubbers having a high 1,4 cis-bond content have high tensile strength. The polybutadiene rubber may have a relatively high or low Mooney viscosity.

Examples of commercially-available polybutadiene rubbers that can be used in accordance with this invention, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; AFDENE 50 and NEODENE BR40, BR45, BR50 and BR60, available from Karbochem (PTY) Ltd. of Bruma, South Africa; KBR 01, NdBr 40, NdBR-45, NdBr 60, KBR 710S, KBR 710H, and KBR 750, available from Kumho Petrochemical Co., Ltd. Of Seoul, South Korea; and DIENE 55NF, 70AC, and 320 AC, available from Firestone Polymers of Akron, Ohio.

To form the core layer, the polybutadiene rubber is used in an amount of at least about 5% by weight based on total weight of composition and is generally present in an amount of about 5% to about 100%, or an amount within a range having a lower limit of 5% or 10% or 20% or 30% or 40% or 50% and an upper limit of 55% or 60% or 70% or 80% or 90% or 95% or 100%. In general, the concentration of polybutadiene rubber is about 45 to about 95 weight percent. Preferably, the rubber material used to form the core layer comprises at least 50% by weight, and more preferably at least 70% by weight, polybutadiene rubber.

The rubber compositions of this invention may be cured, either by pre-blending or post-blending, using conventional curing processes. Suitable curing processes include, for example, peroxide-curing, sulfur-curing, high-energy radiation, and combinations thereof. Preferably, the rubber composition contains a free-radical initiator selected from organic peroxides, high energy radiation sources capable of generating free-radicals, and combinations thereof. In one preferred version, the rubber composition is peroxide-cured. Suitable organic peroxides include, but are not limited to, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. In a particular embodiment, the free radical initiator is dicumyl peroxide, including, but not limited to Perkadox® BC, commercially available from Akzo Nobel. Peroxide free-radical initiators are generally present in the rubber composition in an amount of at least 0.05 parts by weight per 100 parts of the total rubber, or an amount within the range having a lower limit of 0.05 parts or 0.1 parts or 1 part or 1.25 parts or 1.5 parts or 2.5 parts or 5 parts by weight per 100 parts of the total rubbers, and an upper limit of 2.5 parts or 3 parts or 5 parts or 6 parts or 10 parts or 15 parts by weight per 100 parts of the total rubber. Concentrations are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

The rubber compositions preferably include a reactive cross-linking co-agent. Suitable co-agents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particular examples of suitable metal salts include, but are not limited to, one or more metal salts of acrylates, diacrylates, methacrylates, and dimethacrylates, wherein the metal is selected from magnesium, calcium, zinc, aluminum, lithium, and nickel. In a particular embodiment, the co-agent is selected from zinc salts of acrylates, diacrylates, methacrylates, and dimethacrylates. In another particular embodiment, the agent is zinc diacrylate (ZDA). When the co-agent is zinc diacrylate and/or zinc dimethacrylate, the co-agent is typically included in the rubber composition in an amount within the range having a lower limit of 1 or 5 or 10 or 15 or 19 or 20 parts by weight per 100 parts of the total rubber, and an upper limit of 24 or 25 or 30 or 35 or 40 or 45 or 50 or 60 parts by weight per 100 parts of the base rubber.

Radical scavengers such as a halogenated organosulfur or metal salt thereof, organic disulfide, or inorganic disulfide compounds may be added to the rubber composition. These compounds also may function as “soft and fast agents.” As used herein, “soft and fast agent” means any compound or a blend thereof that is capable of making a core: 1) softer (having a lower compression) at a constant “coefficient of restitution” (COR); and/or 2) faster (having a higher COR at equal compression), when compared to a core equivalently prepared without a soft and fast agent. Preferred halogenated organosulfur compounds include, but are not limited to, pentachlorothiophenol (PCTP) and salts of PCTP such as zinc pentachlorothiophenol (ZnPCTP). Using PCTP and ZnPCTP in golf ball inner cores helps produce softer and faster inner cores. The PCTP and ZnPCTP compounds help increase the resiliency and the coefficient of restitution of the core. In a particular embodiment, the soft and fast agent is selected from ZnPCTP, PCTP, ditolyl disulfide, diphenyl disulfide, dixylyl disulfide, 2-nitroresorcinol, and combinations thereof.

The rubber compositions of the present invention also may include “fillers,” which are added to adjust the density and/or specific gravity of the material. Suitable fillers include, but are not limited to, polymeric or mineral fillers, metal fillers, metal alloy fillers, metal oxide fillers and carbonaceous fillers. The fillers can be in any suitable form including, but not limited to, flakes, fibers, whiskers, fibrils, plates, particles, and powders. Rubber regrind, which is ground, recycled rubber material (for example, ground to about 30 mesh particle size) obtained from discarded rubber golf ball cores, also can be used as a filler. The amount and type of fillers utilized are governed by the amount and weight of other ingredients in the golf ball, since a maximum golf ball weight of 45.93 g (1.62 ounces) has been established by the United States Golf Association (USGA).

Suitable polymeric or mineral fillers that may be added to the rubber composition include, for example, precipitated hydrated silica, clay, talc, asbestos, glass fibers, aramid fibers, mica, calcium metasilicate, barium sulfate, zinc sulfide, lithopone, silicates, silicon carbide, tungsten carbide, diatomaceous earth, polyvinyl chloride, carbonates such as calcium carbonate and magnesium carbonate. Suitable metal fillers include titanium, tungsten, aluminum, bismuth, nickel, molybdenum, iron, lead, copper, boron, cobalt, beryllium, zinc, and tin. Suitable metal alloys include steel, brass, bronze, boron carbide whiskers, and tungsten carbide whiskers. Suitable metal oxide fillers include zinc oxide, iron oxide, aluminum oxide, titanium oxide, magnesium oxide, and zirconium oxide. Suitable particulate carbonaceous fillers include graphite, carbon black, cotton flock, natural bitumen, cellulose flock, and leather fiber. Micro balloon fillers such as glass and ceramic, and fly ash fillers can also be used. In a particular aspect of this embodiment, the rubber composition includes filler(s) selected from carbon black, nanoclays (e.g., Cloisite® and Nanofil® nanoclays, commercially available from Southern Clay Products, Inc., and Nanomax® and Nanomer® nanoclays, commercially available from Nanocor, Inc.), talc (e.g., Luzenac HAR® high aspect ratio talcs, commercially available from Luzenac America, Inc.), glass (e.g., glass flake, milled glass, and microglass), mica and mica-based pigments (e.g., Iriodin® pearl luster pigments, commercially available from The Merck Group), and combinations thereof. In a particular embodiment, the rubber composition is modified with organic fiber micropulp.

In addition, the rubber compositions may include antioxidants to prevent the breakdown of the elastomers. Also, processing aids such as high molecular weight organic acids and salts thereof, may be added to the composition. In a particular embodiment, the total amount of additive(s) and filler(s) present in the rubber composition is 15 wt % or less, or 12 wt % or less, or 10 wt % or less, or 9 wt % or less, or 6 wt % or less, or 5 wt % or less, or 4 wt % or less, or 3 wt % or less, based on the total weight of the rubber composition.

The polybutadiene rubber material (base rubber) may be blended with other elastomers in accordance with this invention. Other elastomers include, but are not limited to, polybutadiene, polyisoprene, ethylene propylene rubber (“EPR”), styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof. In one preferred embodiment, the inner core comprises a blend of: a) a first poybutadiene rubber and b) a second polybutadiene rubber, wherein the first and second polybutadiene rubbers are made using different catalysts. Preferred catalysts include those selected from the group consisting of neodymium, nickel, cobalt, aluminum, boron, lithium, titanium, and combinations thereof.

The polymers, free-radical initiators, filler, cross-linking agents, and any other materials used in forming either the golf ball center or any portion of the core, in accordance with invention, may be combined to form a mixture by any type of mixing known to one of ordinary skill in the art. Suitable types of mixing include single pass and multi-pass mixing, and the like. The cross-linking agent, and any other optional additives used to modify the characteristics of the golf ball center or additional layer(s), may similarly be combined by any type of mixing. A single-pass mixing process where ingredients are added sequentially is preferred, as this type of mixing tends to increase efficiency and reduce costs for the process. The preferred mixing cycle is single step wherein the polymer, cis-to-trans catalyst, filler, zinc diacrylate, and peroxide are added in sequence.

In one preferred embodiment, the entire core or at least one core layer in a multi-layered structure is formed of a rubber composition comprising a material selected from the group of natural and synthetic rubbers including, but not limited to, polybutadiene, polyisoprene, ethylene propylene rubber (“EPR”), ethylene-propylene-diene (“EPDM”) rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

As discussed above, single and multi-layered cores can be made in accordance with this invention. In two-layered cores, a thermoset material such as, for example, thermoset rubber, can be used to make the inner core or outer core layer or a thermoplastic material such as, for example, ethylene acid copolymer containing acid groups that are at least partially or fully neutralized can be used to make the inner core or outer core layer. Suitable ionomer compositions include partially-neutralized ionomers and highly-neutralized ionomers (HNPs), including ionomers formed from blends of two or more partially-neutralized ionomers, blends of two or more highly-neutralized ionomers, and blends of one or more partially-neutralized ionomers with one or more highly-neutralized ionomers.

Some examples of suitable thermoplastic ionomers that can be used in accordance with this invention include DuPont® HPF ESX 367, HPF 1000, HPF 2000, HPF AD1035, HPF AD Soft, HPF AD1040, and AD1172 ionomers, commercially available from E. I. du Pont de Nemours and Company. The coefficient of restitution (“COR”), compression, and surface hardness of these materials, as measured on 1.55″ injection molded spheres aged two weeks at 23° C./50% RH, are given in Table 1 below. Other suitable ethylene acid copolymer ionomers and other thermoplastics that can be used to form the core layer(s) are the same materials that can be used to make inner and outer cover layers as discussed further below.

TABLE 1
Properties of Spheres Made from Thermoplastic Ionomers

| | Solid Sphere | Solid Sphere | Solid Sphere Shore D |
|---|---|---|---|
| Example | COR | Compression | Surface Hardness |
| HPF 2000 | 0.860 | 90 | 47 |
| HPF AD1035 | 0.820 | 63 | 42 |
| HPF AD1035 Soft | 0.780 | 33 | 35 |
| HPF AD1172 | 0.800 | 32 | 37 |

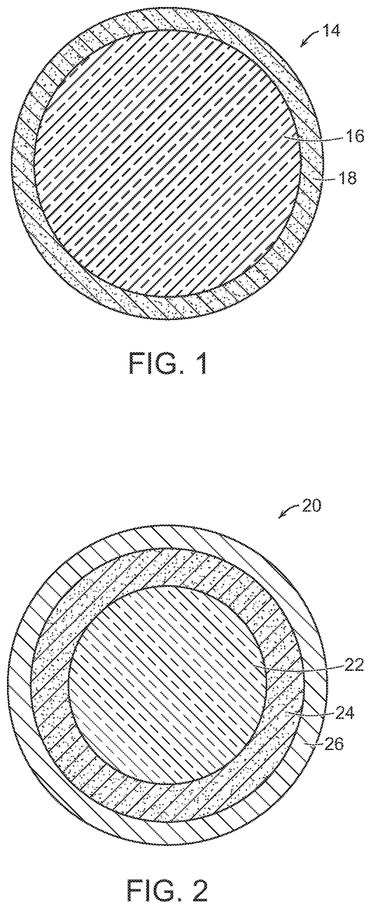

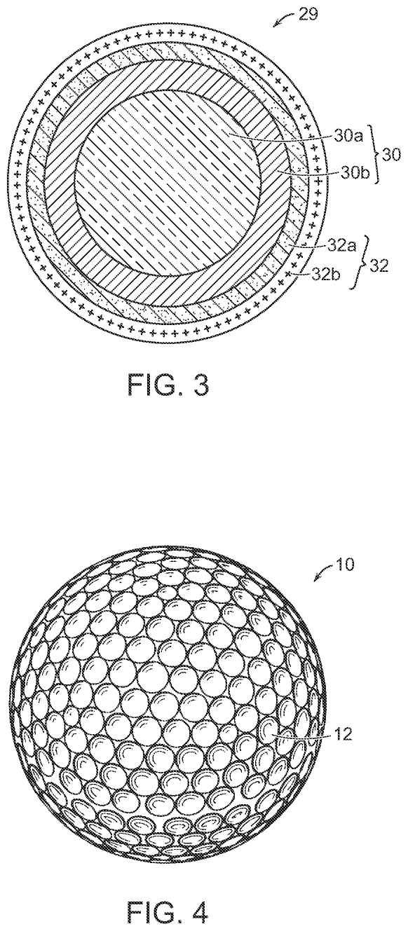

As shown in FIG. 1, the core assembly (14) comprises a relatively large diameter inner core (16) and a surrounding relatively thin outer core layer (18). As shown in FIG. 2, in one embodiment, the golf ball (20) comprises a core having a dual-layered structure including an inner core layer (22) that is preferably made of a polybutadiene rubber composition; and an outer core layer (24) that is preferably made of a thermoset or thermoplastic composition; and a surrounding cover (26). In another embodiment, the inner core (22) is formed from a thermoset or thermoplastic composition; and the outer core (24) is formed from a polybutadiene rubber composition. In FIG. 3, another embodiment of a golf ball is show wherein, the four-piece golf ball (29) contains a dual-core (30) having an inner core (30a) and outer core layer (30b). The dual-core is surrounded by a multi-layered cover having an inner cover layer (32a) and outer cover layer (32b). In FIG. 4, a front view of a finished golf ball that can be made in accordance with this invention is generally indicated at (10). The dimples (12) may have various shapes and be arranged in various patterns to modify the aerodynamic properties of the ball. The dimples (12) may have various shapes and be arranged in various patterns to modify the aerodynamic properties of the ball.

Different ball constructions can be made using the core constructions of this invention as shown in FIGS. 1-4 discussed above. Such golf ball constructions include, for example, five-piece, and six-piece constructions. It should be understood the golf balls shown in FIGS. 1-4 are for illustrative purposes only, and they are not meant to be restrictive. Other golf ball constructions can be made in accordance with this invention.

Dimensions of Inner Core

The Royal and Ancient Golf Club of St. Andrews, Scotland (R&A Rules Limited) and United States Golf Association (USGA) have established standards for the weight, size, and other properties of golf balls. For example, the R&A and USGA have established a maximum weight of 1.62 ounces (45.93 grams) and a minimum size (diameter) of 1.68 inches. For play outside of R&A and USGA rules, the golf balls can be heavier and have a smaller size.

In some embodiments, the golf balls of this invention are manufactured in accordance with R&A and USGA requirements and have a conforming weight, size, and other properties. In other embodiments, the golf balls of this invention are manufactured outside of the R&A and USGA requirements and have a non-conforming weight, size, and/or other properties.

Particularly, the rules of the Royal and Ancient Golf Club of St. Andrews, Scotland (R&A Rules Limited) and United States Golf Association (USGA) require that the diameter of the ball must not be less than 1.680 inches (42.67 mm). By the term, “non-conforming diameter” or “non-conforming size” as used herein, it is meant the ball has a diameter of less than 1.680 inches. For example, in some embodiments, the ball can have a non-conforming diameter, for example, in the range of about 1.480 to less than 1.680 inches. In other embodiments, the ball can have a conforming diameter size that is greater than 1.680 inches. That is, there is no maximum size requirement—the ball can have a diameter of greater than 1.680 inches and still be considered a “conforming” ball—these balls are often referred to as “over-sized” balls. Thus, in one example, the ball has a diameter size in the range of greater than 1.680 inches to about 2.080 inches.

Preferably, the inner core is relatively large in volume. For example, the inner core preferably comprises at least 60% of the total volume and more preferably at least 70% of the total volume of the core sub-assembly. In general, the inner core can have a diameter within a range of about 1.10 to about 1.62 inches. Preferably, the inner core has a diameter size with a lower limit of about 1.10 or 1.15 or 1.20 or 1.25 or 1.30 inches and an upper limit of about 1.40 or 1.45 or 1.50 or 1.55 or 1.62 inches. In one preferred embodiment, the diameter of the inner core is in the range of about 1.10 to about 1.50 inches, more preferably about 1.25 to about 1.45 inches. For example, in one version, the inner core structure has a diameter of about 1.40 inches. Meanwhile, the outer core layer generally has a thickness within a range of about 0.05 to about 0.4 inches. Preferably, the outer core has a thickness with a lower limit of about 0.05 or 0.06 or 0.08 or 0.10 inches and an upper limit of 0.20 or 0.25 or 0.30 or 0.35 or 0.40 inches. In one preferred embodiment, the outer core layer has a thickness in the range of about 0.05 to about 0.20 inches, more preferably about 0.08 to about 0.15 inches. Thus, the dual-layered core structure preferably has an overall diameter within a range of about 1.50 to about 1.60 inches. For example, in one version, the dual-layered core structure has an overall diameter of about 1.55 inches. In another example, the dual-layered core structure has an overall diameter of about 1.58 inches.

Dual-layered core structures containing layers with various diameter, thickness and volume dimensions may be made in accordance with this invention. Some examples of core structures containing layers of varying diameters, thicknesses and volumes are described below in Tables 2 and 2A.

TABLE 2
Sample Core Dimensions

| | | | Volume of | | | | Outer Core | |
|---|---|---|---|---|---|---|---|---|
| | Inner Core | | Inner Core¹ | | Outer Core | | Volume² | |
| | Diameter | | cub | cub | Thickness | | cub | cub |
| Sample | Inches | cms* | in** | cms** | inch | cms | inch | cms |
| A | 1.2 | 3.05 | 0.90 | 14.84 | 0.10 | 0.25 | 0.54 | 8.77 |
| B | 1.3 | 3.30 | 1.15 | 18.81 | 0.125 | 0.32 | 0.80 | 13.20 |
| C | 1.4 | 3.56 | 1.43 | 23.61 | 0.09 | 0.23 | 0.63 | 10.14 |
| D | 1.45 | 3.68 | 1.59 | 26.08 | 0.07 | 0.18 | 0.51 | 8.43 |
| E | 1.5 | 3.81 | 1.77 | 28.94 | 0.055 | 0.14 | 0.41 | 6.87 |

Footnotes
*cms—centimeters
**cub in—cubic inches
***cub cms—cubic centimeters
$\begin{matrix}{}^{1} The Volume of the Inner Core is determined according to the Equation \text{:} \\ V = \frac{4}{3} π {r}^{3} .\end{matrix}$ ²The Volume of the Outer Core is determined according to the Equation:
Total Volume of Core − Volume of Inner Core = Volume of Outer Core
$\begin{matrix}{}^{3} The Total Volume of the Core Assembly is determined according to \\ the Equation \text{:} V = \frac{4}{3} π {r}^{3} .\end{matrix}$

TABLE 2A
Sample Core Dimensions

| | Total Core | | Total Volume of | |
|---|---|---|---|---|
| | Diameter | | Core Assembly³ | |
| Sample | inch | cms | cub inch | cub cms |
| A | 1.40 | 3.56 | 1.44 | 23.61 |
| B | 1.55 | 3.94 | 1.95 | 32.01 |
| C | 1.58 | 4.01 | 2.06 | 33.75 |
| D | 1.59 | 4.04 | 2.10 | 34.51 |
| E | 1.61 | 4.09 | 2.18 | 35.81 |

The core constructions of this invention provide the golf ball with many advantageous mechanical and playing performance properties. Particularly, in the core constructions of this invention, there are specific relationships between the dimensions and compressions of the core layers, which is referred to as “Core Profile” herein and described in further detail below. Preferably, the total core assembly has a Core Profile of about 1.8 or greater. The golf balls of this invention are particularly effective, because they have a relatively large inner core (center) and relatively thin outer core layer. In one preferred embodiment, the inner core has a diameter of 1.39 inches and the total core assembly has a diameter of 1.55 inches. Preferably, the inner core has a Coefficient of Restitution (COR) of at least 0.78, and the total core assembly has a COR of at least 0.80. The finished golf ball preferably has a COR of at least 0.80. The inner core of the golf ball preferably has a compression in the range of about 20 to about 50 and the compression of the total core assembly is preferably in the range of about 60 to about 110. The finished golf ball preferably has a compression of between about 70 and 110.

These features and properties allow players to generate greater ball velocity off the tee and achieve greater distance with their drives. The balls tend to travel a far distance when struck by a driver club from a tee. At the same time, the spin rate and launch angle of the ball is controlled off the driver. The spin rate refers to the ball's rate of rotation after it is hit by a club. The launch angle is the angle relative to the ground that the ball leaves after being struck by the club head. The overall trajectory of the ball is then determined by the initial launch conditions and the aerodynamic properties of the ball. Balls having a relatively high spin rate can be difficult to control in drives and shorter in distance, particularly for recreational players. For such players, the back spin can have an angled axis and form lift in a sideways direction such that the ball can drift far-off the intended direction. In the present invention, the balls can be designed to have higher driver velocity off the tee, higher launch angles and lower driver spin. Thus, the ball can travel far distances and the ball's flight path can be controlled more easily. This velocity and control allow the player to make better driver shots.

Core Profile

As discussed above, the core constructions of this invention provide the ball with many advantageous properties. In particular, the core constructions have specific relationships between the dimensions of the core layers and compression of the core layers, which is referred to as “Core Profiles” herein and described further below in Tables 3 and 4.

TABLE 3
(Examples)

| | | | Total | Inner | |
|---|---|---|---|---|---|
| | Inner Core | Total Core | Core | Core | |
| | Diameter | Diameter | Compres- | Compres- | Core |
| Example | (In) | (In) | sion (DCM) | sion (DCM) | Profile* |
| 1 | 1.25 | 1.55 | 90 | 40 | 1.81 |
| 2 | 1.45 | 1.55 | 70 | 20 | 3.27 |
| 3 | 1.39 | 1.55 | 75 | 35 | 1.92 |
| 4 | 1.39 | 1.58 | 80 | 20 | 3.52 |
| 5 | 1.25 | 1.58 | 90 | 20 | 3.56 |
| 6 | 1.25 | 1.60 | 100 | 20 | 3.90 |

*Core Profile is calculated based on Equation 1.

$$\frac{Inner Core Diameter}{Total Core Diameter} \times \frac{Total Core Compression}{Inner Core Compression} = Core Profile \qquad Equation 1$$

TABLE 4
(Comparative Examples)

| | | | Total | Inner | |
|---|---|---|---|---|---|
| | Inner Core | Total Core | Core | Core | |
| | Diameter | Diameter | Compression | Compression | Core |
| Example | (In) | (In) | (DCM) | (DCM) | Profile* |
| Comp. A | 1.13 | 1.55 | 45 | 26 | 1.26 |
| Comp. B | 1.00 | 1.55 | 45 | 19 | 1.53 |
| Comp. C | 1.00 | 1.55 | 53 | 25 | 1.37 |
| Comp. D | 1.00 | 1.55 | 55 | 25 | 1.42 |
| Comp. E | 1.00 | 1.55 | 50 | 25 | 1.29 |
| Comp. F | 1.00 | 1.55 | 65 | 25 | 1.68 |
| Comp. G | 1.25 | 1.55 | 70 | 40 | 1.41 |
| Comp. H | 1.39 | 1.55 | 70 | 40 | 1.57 |

*Core Profile is calculated based on Equation 1.

In the present invention, the golf ball preferably comprises a core assembly having: a) an inner core comprising a thermoset or thermoplastic composition; the inner core having an inner core diameter (ICD) in the range of about 1.2 to about 1.5 inches and an outer surface hardness (H_{inner core surface}), a center hardness (H_{inner core center}), an inner core volume (ICV) and an inner core compression (ICC); and b) an outer core layer comprising a thermoset or thermoplastic composition, the outer core layer being disposed about the inner core and having a thickness in the range of about 0.05 to about 0.2 inches such that the total core assembly has a total core diameter (TCD) of between about 1.5 to about 1.6 inches, the outer core having an outer surface hardness (H_{outer surface of OC}), a midpoint hardness (H_{midpoint of OC}), an outer core volume (OCV) and a total core compression (TCC), wherein ICV is greater than OCV and the core assembly has a core profile of about 1.8 or greater. In another preferred embodiment, the core profile is greater than 2.0. In yet another preferred embodiment, the core profile is greater than 3.0. In one preferred embodiment, the outer core volume (OCV) is less than or equal to the value, “X,” calculated according to the Equation: (0.9)(ICV)=X. Thus, in this example, if the inner core volume (ICV) is 0.9 cubic inches, then the outer core volume (OCV) is less than or equal to 0.81. In another preferred embodiment, the total core compression (TCC) is greater than or equal to the value, “Y,” calculated according to the Equation: (2.0)(ICC)=Y. Thus, in this example, if the inner core compression (ICC) is 40 DCM, then the total core compression (TCC) is greater than or equal to about 80 DCM.

Hardness of Inner Core

The hardness of the core sub-assembly (inner core and outer core layer) is an important property. In general, cores with relatively high hardness values have higher compression and tend to have good durability and resiliency. However, some high compression balls are stiff and this may have a detrimental effect on shot control and placement. Thus, the optimum balance of hardness in the core assembly needs to be attained. The present invention provides core assemblies having both good resiliency (CoR) and compression properties. In general, a core with higher resiliency will reach a higher velocity when struck by a golf club and travel longer distances. The “feel” of the ball also is important and this generally refers to the sensation that a player experiences when striking the ball with the club. The feel of a ball is a difficult property to quantify. Most players prefer balls having a soft feel, because the player experience a more natural and comfortable sensation when their club face makes contact with these balls. The feel of the ball primarily depends upon the hardness and compression of the ball.

In one preferred golf ball, the inner core (center) has a “positive” hardness gradient (that is, the outer surface of the inner core is harder than its geometric center); and the outer core layer has a “positive” hardness gradient (that is, the outer surface of the outer core layer is harder than the inner surface of the outer core layer.) In such cases where both the inner core and outer core layer each has a “positive” hardness gradient, the outer surface hardness of the outer core layer is preferably greater than the hardness of the geometric center of the inner core.

In an alternative version, the inner core may have a positive hardness gradient; and the outer core layer may have a “zero” hardness gradient (that is, the hardness values of the outer surface of the outer core layer and the inner surface of the outer core layer are substantially the same) or a “negative” hardness gradient (that is, the outer surface of the outer core layer is softer than the inner surface of the outer core layer.) In a second alternative version, the inner core may have a zero or negative hardness gradient; and the outer core layer may have a positive hardness gradient. Still yet, in another embodiment, both the inner core and outer core layers have zero or negative hardness gradients.

The core layers have positive, negative, or zero hardness gradients defined by hardness measurements made at the outer surface of the inner core (or outer surface of the outer core) and radially inward towards the center of the inner core (or inner surface or midpoint of the outer core). These measurements are made typically at 2-mm increments as described in the test methods below. In general, the hardness gradient is determined by subtracting the hardness value at the innermost portion of the component being measured (for example, the center of the inner core or midpoint of the outer core layer) from the hardness value at the outer surface of the component being measured (for example, the outer surface of the inner core or outer surface of the outer core layer). Once one or more core layers surround a layer of interest, the exact midpoint may be difficult to determine, therefore, for the purposes of the present invention, the measurement of “midpoint” hardness of a layer is taken within plus or minus 1 mm of the measured midpoint of the layer.

The inner core preferably has a geometric center hardness (H_{inner core center}) of about 5 Shore D or greater. For example, the (H_{inner core center}) may be in the range of about 5 to about 88 Shore D and more particularly within a range having a lower limit of about 5 or 10 or 18 or 20 and an upper limit of about 80 or 82 or 84 or 88 Shore D. In another example, the center hardness of the inner core (H_{inner core center}), as measured in Shore C units, is preferably about 10 Shore C or greater; for example, the H_{inner core center} may have a lower limit of about 10 or 14 or 16 or 20 and an upper limit of about 78 or 80 or 84 or 90 Shore C. Concerning the outer surface hardness of the inner core (H_{inner core surface}), this hardness is preferably about 12 Shore D or greater; for example, the H_{inner core surface} may fall within a range having a lower limit of about 12 or 15 or 18 or 20 and an upper limit of about 80 or 84 or 86 or 90 Shore D. In one version, the outer surface hardness of the inner core (H_{inner core surface}), as measured in Shore C units, has a lower limit of about 13 or 15 or 18 or 20 and an upper limit of about 86 or 88 or 90 or 92 Shore C. In another version, the geometric center hardness (H_{inner core center}) is in the range of about 10 Shore C to about 50 Shore C; and the outer surface hardness of the inner core (H_{inner core surface}) is in the range of about 5 Shore C to about 50 Shore C.

On the other hand, the outer core layer preferably has an outer surface hardness (H_{outer surface of OC}) of about 40 Shore D or greater, and more preferably within a range having a lower limit of about 40 or 42 or 44 or 46 and an upper limit of about 85 or 87 or 88 or 90 Shore D. The outer surface hardness of the outer core layer (flouter surface of OC), as measured in Shore C units, preferably has a lower limit of about 40 or 42 or 45 or 48 and an upper limit of about 88 or 90 or 92 or 95 Shore C. And, the midpoint hardness of the outer core layer (H_{midpoint of OC}) preferably has a hardness of about 40 Shore D or greater, and more preferably within a range having a lower limit of about 40 or 42 or 46 or 48 or 50 and an upper limit of about 80 or 82 or 85 or 88 or 90 Shore D. The midpoint hardness of the outer core layer (H_{midpoint of OC}), as measured in Shore C units, preferably has a lower limit of about 40 or 42 or 44 or 45 or 47 and an upper limit of about 85 or 88 or 90 or 92 or 95 Shore C.

The core structure also has a hardness gradient across the entire core assembly. In one embodiment, the (H_{inner core center}) is in the range of about 10 Shore C to about 60 Shore C, preferably about 13 Shore C to about 55 Shore C; and the (H_{outer surface of OC}) is in the range of about 65 to about 96 Shore C, preferably about 68 Shore C to about 94 Shore C to provide a positive hardness gradient across the core assembly. The total core gradient across the core assembly is preferably in the range of about 10 to about 40 units, more preferably in the range of about 15 to about 30 units. In another embodiment, there is a zero or negative hardness gradient across the core assembly. For example, the center of the core (H_{inner core center}) may have a hardness gradient in the range of 20 to 90 Shore C; and the outer surface of the outer core may have a hardness gradient in the range of 10 to 80 Shore C. The hardness gradient across the core assembly will vary based on several factors including, but not limited to, the dimensions of the inner core, intermediate core, and outer core layers.

Intermediate Layer

In one preferred embodiment, an intermediate layer is disposed between the single or multi-layered core and surrounding cover layer. These intermediate layers also can be referred to as casing or inner cover layers. The intermediate layer can be formed from any materials known in the art, including thermoplastic and thermosetting materials, but preferably is formed of an ionomer composition comprising an ethylene acid copolymer containing acid groups that are at least partially neutralized. Suitable ethylene acid copolymers that may be used to form the intermediate layers are generally referred to as copolymers of ethylene; C₃ to C₈ α, β-ethylenically unsaturated mono- or dicarboxylic acid; and optional softening monomer. These ethylene acid copolymer ionomers also can be used to form the inner core and outer core layers as described above.

Cover Structure

As noted above, the golf ball assembly generally comprises a core assembly that is enclosed with a protective cover layer. The ball may contain one or more cover layers. For example, a golf ball having a single-layered cover may be made. In another version, a golf ball having a two-layered cover including inner and outer cover layers may be made.

The cover layers of this invention provide the ball with a variety of advantageous mechanical properties such as, for example, high impact durability and high shear-resistance levels. In addition, the multi-layered cover, in combination with the core layer, helps impart high resiliency to the golf balls. as discussed further below. In general, the hardness and thickness of the different cover layers may vary depending upon the desired ball construction. In addition, as discussed above, an intermediate layer may be disposed between the core and cover layers. The cover layers preferably have good impact durability, toughness, and wear-resistance.

Suitable conventional materials that can be used to form a cover layer include, but are not limited to, polyurethanes; polyureas; copolymers, blends and hybrids of polyurethane and polyurea; olefin-based copolymer ionomer resins (for example, Surlyn® ionomer resins and DuPont HPF® 1000, HPF® 2000, and HPF® 1035; and HPF® AD 1172, commercially available from DuPont; Iotek® ionomers, commercially available from ExxonMobil Chemical Company; Amplify® TO ionomers of ethylene acrylic acid copolymers, commercially available from The Dow Chemical Company; and Clarix® ionomer resins, commercially available from A. Schulman Inc.); polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, commercially available from Arkema Inc; cross-linked trans-polyisoprene and blends thereof; polyester-based thermoplastic elastomers, such as Hytrel®, commercially available from DuPont or RiteFlex®, commercially available from Ticona Engineering Polymers; polyurethane-based thermoplastic elastomers, such as Elastollan®, commercially available from BASF; synthetic or natural vulcanized rubber; and combinations thereof. Polyurethanes, polyureas, and hybrids of polyurethanes-polyureas are particularly desirable because these materials can be used to make a golf ball having high resiliency and a soft feel. By the term, “hybrids of polyurethane and polyurea,” it is meant to include copolymers and blends thereof.

In general, polyurethanes contain urethane linkages formed by reacting an isocyanate group (—N═C═O) with a hydroxyl group (OH). The polyurethanes are produced by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with short-chain diols (OH—R′—OH). The resulting polyurethane has elastomeric properties because of its “hard” and “soft” segments, which are covalently bonded together. This phase separation occurs because the mainly non-polar, low melting soft segments are incompatible with the polar, high melting hard segments. The hard segments, which are formed by the reaction of the diisocyanate and low molecular weight chain-extending diol, are relatively stiff and immobile. The soft segments, which are formed by the reaction of the diisocyanate and long chain diol, are relatively flexible and mobile. Because the hard segments are covalently coupled to the soft segments, they inhibit plastic flow of the polymer chains, thus creating elastomeric resiliency.

Thermoplastic polyurethanes have minimal cross-linking; any bonding in the polymer network is primarily through hydrogen bonding or other physical mechanism. Because of their lower level of cross-linking, thermoplastic polyurethanes are relatively flexible. The cross-linking bonds in thermoplastic polyurethanes can be reversibly broken by increasing temperature such as during molding or extrusion. That is, the thermoplastic material softens when exposed to heat and returns to its original condition when cooled. On the other hand, thermoset polyurethanes become irreversibly set when they are cured. The cross-linking bonds are irreversibly set and are not broken when exposed to heat. Thus, thermoset polyurethanes, which typically have a high level of cross-linking, are relatively rigid.

Suitable ionomer compositions include, for example, partially-neutralized ionomers and highly-neutralized ionomers (HNPs), including ionomers formed from blends of two or more partially-neutralized ionomers, blends of two or more highly-neutralized ionomers, and blends of one or more partially-neutralized ionomers with one or more highly-neutralized ionomers. For purposes of the present disclosure, “HNP” refers to an acid copolymer after at least 70% of all acid groups present in the composition are neutralized. Preferred ionomers are salts of O/X- and O/X/Y-type acid copolymers, wherein O is an α-olefin, X is a C₃-C₈ α,β-ethylenically unsaturated carboxylic acid, and Y is a softening monomer. 0 is preferably selected from ethylene and propylene. X is preferably selected from methacrylic acid, acrylic acid, ethacrylic acid, crotonic acid, and itaconic acid. Methacrylic acid and acrylic acid are particularly preferred. Y is preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate.

Preferred O/X and O/X/Y-type copolymers include, without limitation, ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/isobutyl (meth)acrylate, ethylene/(meth)acrylic acid/methyl (meth)acrylate, ethylene/(meth)acrylic acid/ethyl (meth)acrylate terpolymers, and the like. The term, “copolymer,” as used herein, includes polymers having two types of monomers, those having three types of monomers, and those having more than three types of monomers. Preferred α, β-ethylenically unsaturated mono- or dicarboxylic acids are (meth) acrylic acid, ethacrylic acid, maleic acid, crotonic acid, fumaric acid, itaconic acid. (Meth) acrylic acid is most preferred. As used herein, “(meth) acrylic acid” means methacrylic acid and/or acrylic acid. Likewise, “(meth) acrylate” means methacrylate and/or acrylate.

In a particularly preferred version, highly neutralized E/X- and E/X/Y-type acid copolymers, wherein E is ethylene, X is a C₃-C₈ α,β-ethylenically unsaturated carboxylic acid, and Y is a softening monomer are used. X is preferably selected from methacrylic acid, acrylic acid, ethacrylic acid, crotonic acid, and itaconic acid. Methacrylic acid and acrylic acid are particularly preferred. Y is preferably an acrylate selected from alkyl acrylates and aryl acrylates and preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate. Preferred E/X/Y-type copolymers are those wherein X is (meth) acrylic acid and/or Y is selected from (meth) acrylate, n-butyl (meth) acrylate, isobutyl (meth) acrylate, methyl (meth) acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate.

The amount of ethylene in the acid copolymer is typically at least 15 wt. %, preferably at least 25 wt. %, more preferably least 40 wt. %, and even more preferably at least 60 wt. %, based on total weight of the copolymer. The amount of C₃ to C₈ α, β-ethylenically unsaturated mono- or dicarboxylic acid in the acid copolymer is typically from 1 wt. % to 35 wt. %, preferably from 5 wt. % to 30 wt. %, more preferably from 5 wt. % to 25 wt. %, and even more preferably from 10 wt. % to 20 wt. %, based on total weight of the copolymer. The amount of optional softening comonomer in the acid copolymer is typically from 0 wt. % to 50 wt. %, preferably from 5 wt. % to 40 wt. %, more preferably from 10 wt. % to 35 wt. %, and even more preferably from 20 wt. % to 30 wt. %, based on total weight of the copolymer. “Low acid” and “high acid” ionomeric polymers, as well as blends of such ionomers, may be used. In general, low acid ionomers are considered to be those containing 16 wt. % or less of acid moieties, whereas high acid ionomers are considered to be those containing greater than 16 wt. % of acid moieties.

The various O/X, E/X, O/X/Y, and E/X/Y-type copolymers are at least partially neutralized with a cation source, optionally in the presence of a high molecular weight organic acid, such as those disclosed in U.S. Pat. No. 6,756,436, the entire disclosure of which is hereby incorporated herein by reference. The acid copolymer can be reacted with the optional high molecular weight organic acid and the cation source simultaneously, or prior to the addition of the cation source. Suitable cation sources include, but are not limited to, metal ion sources, such as compounds of alkali metals, alkaline earth metals, transition metals, and rare earth elements; ammonium salts and monoamine salts; and combinations thereof. Preferred cation sources are compounds of magnesium, sodium, potassium, cesium, calcium, barium, manganese, copper, zinc, lead, tin, aluminum, nickel, chromium, lithium, and rare earth metals.

Normally, an ionomer is made by polymerizing a monomer containing a free carboxylic acid group and α-olefin; and neutralizing at least some of the acid groups with a metal cation. For example, ethylene and methacrylic acid first may be reacted to form the acid polymer as shown in the following diagram:

Production of Acid Polymer

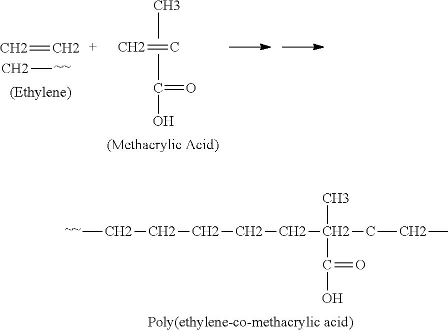

Then, the ionomer may be formed through neutralization by reacting the acid polymer with a cation source (for example, a sodium or zinc cation source). For example, the acid polymer may be reacted with NaOH or ZnCO₃. In one example, the resulting polymer is a sodium salt as shown in the following diagram:

Production of Ionomer

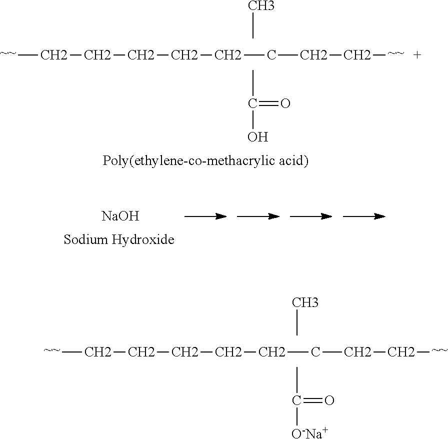

In a dual-layered cover structure, wherein there is an outer cover layer overlying an inner cover layer, the hardness levels of the cover layers may vary. For example, in a “hard-over-soft” version, the outer surface hardness of the outer cover layer is preferably greater than the midpoint hardness of the inner cover layer. Alternatively, in a “soft-over-hard” version, a relatively soft outer cover may be disposed about a relatively hard inner cover. As described above, compositions comprising an ionomer or a blend of ionomers can be used to form the cover layers.

If the ball includes an inner cover layer, the hardness (midpoint) is normally about 50 Shore D or greater, more preferably about 55 Shore D or greater, and most preferably about 60 Shore D or greater. In one embodiment, the inner cover has a Shore D hardness of about 62 to about 90 Shore D. In one example, the inner cover has a hardness of about 68 Shore D or greater. In addition, the thickness of the inner cover layer is preferably about 0.015 inches to about 0.100 inches, more preferably about 0.020 inches to about 0.080 inches, and most preferably about 0.030 inches to about 0.050 inches.

The outer cover preferably has a thickness within a range having a lower limit of about 0.004 or 0.010 or 0.020 or 0.030 or 0.040 inches and an upper limit of about 0.050 or 0.055 or 0.065 or 0.070 or 0.080 inches. Preferably, the thickness of the outer cover is about 0.020 inches or less. In some embodiments, the outer cover has a surface hardness of 65 Shore D or less, or 55 Shore D or less, or 50 Shore D or less, or 50 Shore D or less, or 45 Shore D or less. In one example, the outer cover has a hardness in the range of about 20 to about 59 Shore D. In another example, the outer cover has a hardness in the range of about 25 to about 55 Shore D.

For example, a composition comprising ethylene acid copolymer ionomers such as, for example, Surlyns® and Nucrels® (DuPont) can be used to form the cover layers. In another example, cover layer(s) formed from a composition comprising a high acid ionomer and maleic anhydride-grafted non-ionomeric polymer can be used. A particularly suitable high acid ionomer is Surlyn 8150®, which is a copolymer of ethylene and methacrylic acid, having an acid content of 19 wt %, which is 45% neutralized with sodium. A particularly suitable maleic anhydride-grafted polymer is Fusabond 525D® (DuPont). Fusabond 525D® is a maleic anhydride-grafted, metallocene-catalyzed ethylene-butene copolymer having about 0.9 wt % maleic anhydride grafted onto the copolymer.

Compositions comprising a 50/45/5 blend of Surlyn 8940/Surlyn 9650Nucrel 960, can be used. In yet another version, the cover layer(s) can be formed from a composition comprising a 50/25/25 blend of Surlyn® 8940/Surlyn® 9650/Surlyn® 9910. Compositions comprising a 50/50 blend of Surlyn® 8940/Surlyn® 9650, also can be used. Surlyn® 8940 is an E/MAA copolymer in which the MAA acid groups have been partially neutralized with sodium ions. Surlyn® 9650 and Surlyn® 9910 are two different grades of E/MAA copolymer in which the MAA acid groups have been partially neutralized with zinc ions. Nucrel 960 is an E/MAA copolymer resin nominally made with 15 wt % methacrylic acid.

Nucrel® 9-1 (a copolymer of ethylene with 23.5% n-butyl acrylate, and about 9% methacrylic acid that is unneutralized); Nucrel® 2940 (a copolymer of ethylene and about 19% methacrylic acid that is unneutralized); Nucrel® 0403 (a copolymer of ethylene and about 4% methacrylic acid that is unneutralized); and Nucrel® 960 (a copolymer of ethylene and about 15% methacrylic acid that is unneutralized) also may be used. Surlyn® 6320 (a copolymer of ethylene with 23.5% n-butyl acrylate, and about 9% methacrylic acid that is about 50% neutralized with a magnesium cation source); Surlyn® 8150 (a copolymer of ethylene with about 19% methacrylic acid that is about 45% neutralized with a sodium cation source); Surlyn® 8320 (a copolymer of ethylene with 23.5% n-butyl acrylate, and about 9% methacrylic acid that is about 52% neutralized with a sodium cation source); and Surlyn® 9120 (a copolymer of ethylene with about 19% methacrylic acid that is about 36% neutralized with a zinc cation source); and Surlyn® 9320 (a copolymer of ethylene with 23.5% n-butyl acrylate, and about 9% methacrylic acid that is about 41% neutralized with a zinc cation source) also may be used. Primacor® 3150, 3330, 59801, 5986, and 59901 acid copolymers, commercially available from the Dow Chemical Company also may be used.

In one particularly preferred version, a 50%/50% by weight blend of Surlyn® 8940 (sodium neutralized-ethylene acid copolymer ionomer)/7940 (lithium neutralized—ethylene acid copolymer ionomer) is used to form the outer cover layer. Other Surlyn® ionomers include, for example, Surlyn® 9910 (zinc neutralized); Surlyn® 7930 (lithium neutralized) Surlyn® 8940 is a copolymer of ethylene with methacrylic acid with about 15 weight percent acid which is about 29% neutralized with sodium ions. This resin has an average melt flow index of about 2.8. Surlyn® 9910 is a copolymer of ethylene and methacrylic acid with about 15 weight percent acid which is about 58% neutralized with zinc ions. The average melt flow index of Surlyn® 9910 is about 0.7. Surlyn® 7930 and Surlyn® 7940 are two similar lithium neutralized poly(ethylene-methacrylic acid) ionomers differing in melt indexes.

Golf Ball Construction

The inner core may be formed by any suitable technique including compression and injection molding methods. The outer core layer, which surrounds the inner core, is formed by molding compositions over the inner core. Compression or injection molding techniques may be used to form the other layers of the core assembly. Then, the cover layers are applied over the core assembly. Prior to this step, the core structure may be surface-treated to increase the adhesion between its outer surface and the next layer that will be applied over the core. Such surface-treatment may include mechanically or chemically-abrading the outer surface of the core. For example, the core may be subjected to corona-discharge, plasma-treatment, silane-dipping, or other treatment methods known to those in the art.

The cover layers are formed over the core or ball sub-assembly (the core structure and any intermediate layers disposed about the core) using a suitable technique such as, for example, compression-molding, flip-molding, injection-molding, retractable pin injection-molding, reaction injection-molding (RIM), liquid injection-molding, casting, spraying, powder-coating, vacuum-forming, flow-coating, dipping, spin-coating, and the like. Preferably, each cover layer is separately formed over the ball sub-assembly

Conventional compression and injection-molding and other methods can be used to form cover layers over the core or ball sub-assembly. In general, compression molding normally involves first making half (hemispherical) shells by injection-molding the composition in an injection mold. This produces semi-cured, semi-rigid half-shells (or cups). Then, the half-shells are positioned in a compression mold around the core or ball sub-assembly. Heat and pressure are applied and the half-shells fuse together to form a cover layer over the core or sub-assembly. Compression molding also can be used to cure the cover composition after injection-molding. For example, a thermally-curable composition can be injection-molded around a core in an unheated mold. After the composition is partially hardened, the ball is removed and placed in a compression mold. Heat and pressure are applied to the ball and this causes thermal-curing of the outer cover layer.

Retractable pin injection-molding (RPIM) methods, which can be used for making thermoplastic covers including ethylene acid copolymer ionomer covers and thermoplastic polyurethane covers, generally involve using upper and lower mold cavities that are mated together. The upper and lower mold cavities form a spherical interior cavity when they are joined together. The mold cavities used to form the outer cover layer have interior dimple cavity details. The cover material conforms to the interior geometry of the mold cavities to form a dimple pattern on the surface of the ball. The injection-mold includes retractable support pins positioned throughout the mold cavities. The retractable support pins move in and out of the cavity. The support pins help maintain the position of the core or ball sub-assembly while the molten composition flows through the mold gates. The molten composition flows into the cavity between the core and mold cavities to surround the core and form the cover layer. Other methods can be used to make the cover including, for example, reaction injection-molding (RIM), liquid injection-molding, casting, spraying, powder-coating, vacuum-forming, flow-coating, dipping, spin-coating, and the like.

In a typical thermoset polyurethane casting process, a polyurethane prepolymer and curing agent can be mixed in a motorized mixer inside a mixing head by metering amounts of the curative and prepolymer through the feed lines. The preheated lower mold cavities can be filled with the reactive polyurethane and curing agent mixture. Likewise, the preheated upper mold cavities can be filled with the reactive mixture. The lower and upper mold cavities are filled with substantially the same amount of reactive mixture. After the reactive mixture has resided in the lower mold cavities for a sufficient time period, the golf ball subassembly can be lowered at a controlled speed into the reacting mixture. Ball cups can hold the subassemblies by applying reduced pressure (or partial vacuum). After sufficient gelling, the vacuum can be removed and the subassembly can be released. Then, the upper half-molds can be mated with the lower half-molds. An exothermic reaction occurs when the polyurethane prepolymer and curing agent are mixed and this continues until the material solidifies around the subassembly. The molded balls can then be cooled in the mold and removed when the molded cover layer is hard enough to be handled without deforming.

As discussed above, an inner cover layer or intermediate layer, preferably formed from an ethylene acid copolymer ionomer composition, can be formed between the core or ball sub-assembly and cover layer. The intermediate layer comprising the ionomer composition can be formed using a conventional technique such as, for example, compression or injection-molding. For example, the ionomer composition may be injection-molded or placed in a compression mold to produce half-shells. These shells are placed around the core in a compression mold, and the shells fuse together to form an intermediate layer. Alternatively, the ionomer composition is injection-molded directly onto the core using retractable pin injection-molding.

Application of Primer and Top-Coats

After the golf balls have been removed from the mold, they may be subjected to finishing steps such as flash-trimming, surface-treatment, marking, and application of coatings in accordance with this invention.

For example, in traditional white-colored golf balls, the white-pigmented outer cover layer may be surface-treated using a suitable method such as, for example, corona, plasma, or ultraviolet (UV) light-treatment. In another finishing process, the golf balls are painted with one or more paint coatings. For example, white or clear primer paint may be applied first to the surface of the ball and then indicia may be applied over the primer followed by application of a clear polyurethane top-coat. Indicia such as trademarks, symbols, logos, letters, and the like may be printed on the outer cover or prime-coated layer, or top-coated layer using pad-printing, ink-jet printing, dye-sublimation, or other suitable printing methods. Any of the surface coatings may contain a fluorescent optical brightener.

Test Methods

Hardness.

The center hardness of a core is obtained according to the following procedure. The core is gently pressed into a hemispherical holder having an internal diameter approximately slightly smaller than the diameter of the core, such that the core is held in place in the hemispherical portion of the holder while concurrently leaving the geometric central plane of the core exposed. The core is secured in the holder by friction, such that it will not move during the cutting and grinding steps, but the friction is not so excessive that distortion of the natural shape of the core would result. The core is secured such that the parting line of the core is roughly parallel to the top of the holder. The diameter of the core is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the center of the core is found with a center square and carefully marked and the hardness is measured at the center mark according to ASTM D-2240. Additional hardness measurements at any distance from the center of the core can then be made by drawing a line radially outward from the center mark, and measuring the hardness at any given distance along the line, typically in 2 mm increments from the center. The hardness at a particular distance from the center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of a golf ball layer is measured on the actual outer surface of the layer and is obtained from the average of a number of measurements taken from opposing hemispheres, taking care to avoid making measurements on the parting line of the core or on surface defects, such as holes or protrusions. Hardness measurements are made pursuant to ASTM D-2240 “Indentation Hardness of Rubber and Plastic by Means of a Durometer.” Because of the curved surface, care must be taken to ensure that the golf ball or golf ball sub-assembly is centered under the durometer indenter before a surface hardness reading is obtained. A calibrated, digital durometer, capable of reading to 0.1 hardness units is used for the hardness measurements. The digital durometer must be attached to, and its foot made parallel to, the base of an automatic stand. The weight on the durometer and attack rate conforms to ASTM D-2240.

In certain embodiments, a point or plurality of points measured along the “positive” or “negative” gradients may be above or below a line fit through the gradient and its outermost and innermost hardness values. In an alternative preferred embodiment, the hardest point along a particular steep “positive” or “negative” gradient may be higher than the value at the innermost portion of the inner core (the geometric center) or outer core layer (the inner surface)—as long as the outermost point (i.e., the outer surface of the inner core) is greater than (for “positive”) or lower than (for “negative”) the innermost point (i.e., the geometric center of the inner core or the inner surface of the outer core layer), such that the “positive” and “negative” gradients remain intact.

As discussed above, the direction of the hardness gradient of a golf ball layer is defined by the difference in hardness measurements taken at the outer and inner surfaces of a particular layer. The center hardness of an inner core and hardness of the outer surface of an inner core in a single-core ball or outer core layer are readily determined according to the test procedures provided above. The outer surface of the inner core layer (or other optional intermediate core layers) in a dual-core ball are also readily determined according to the procedures given herein for measuring the outer surface hardness of a golf ball layer, if the measurement is made prior to surrounding the layer with an additional core layer. Once an additional core layer surrounds a layer of interest, the hardness of the inner and outer surfaces of any inner or intermediate layers can be difficult to determine. Therefore, for purposes of the present invention, when the hardness of the inner or outer surface of a core layer is needed after the inner layer has been surrounded with another core layer, the test procedure described above for measuring a point located 1 mm from an interface is used.

Also, it should be understood that there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers. It also should be understood that the two measurement techniques are not linearly related and, therefore, one hardness value cannot easily be correlated to the other. Shore hardness (for example, Shore C or Shore D or Shore A hardness) was measured according to the test method ASTM D-2240.

Compression.

As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, compression refers to Soft Center Deflection Index (“SCDI”). The SCDI is a program change for the Dynamic Compression Machine (“DCM”) that allows determination of the pounds required to deflect a core 10% of its diameter. The DCM is an apparatus that applies a load to a core or ball and measures the number of inches the core or ball is deflected at measured loads. A crude load/deflection curve is generated that is fit to the Atti compression scale that results in a number being generated that represents an Atti compression. The DCM does this via a load cell attached to the bottom of a hydraulic cylinder that is triggered pneumatically at a fixed rate (typically about 1.0 ft/s) towards a stationary core. Attached to the cylinder is an LVDT that measures the distance the cylinder travels during the testing timeframe. A software-based logarithmic algorithm ensures that measurements are not taken until at least five successive increases in load are detected during the initial phase of the test. The SCDI is a slight variation of this set up. The hardware is the same, but the software and output has changed. With the SCDI, the interest is in the pounds of force required to deflect a core x amount of inches. That amount of deflection is 10% percent of the core diameter. The DCM is triggered, the cylinder deflects the core by 10% of its diameter, and the DCM reports back the pounds of force required (as measured from the attached load cell) to deflect the core by that amount. The value displayed is a single number in units of pounds.

Coefficient of Restitution (“COR”).

The COR is determined according to a known procedure, wherein a golf ball or golf ball sub-assembly (for example, a golf ball core) is fired from an air cannon at two given velocities and a velocity of 125 ft/s is used for the calculations. Ballistic light screens are located between the air cannon and steel plate at a fixed distance to measure ball velocity. As the ball travels toward the steel plate, it activates each light screen and the ball's time period at each light screen is measured. This provides an incoming transit time period which is inversely proportional to the ball's incoming velocity. The ball makes impact with the steel plate and rebounds so it passes again through the light screens. As the rebounding ball activates each light screen, the ball's time period at each screen is measured. This provides an outgoing transit time period which is inversely proportional to the ball's outgoing velocity. The COR is then calculated as the ratio of the ball's outgoing transit time period to the ball's incoming transit time period (COR=Vₒᵤₜ/Vᵢₙ=Tᵢₙ/Tₒᵤₜ).

It is understood that the golf ball manufacturing methods, compositions, constructions, components, and products described and illustrated herein represent only some embodiments of the invention. It is appreciated by those skilled in the art that various changes and additions can be made to the methods, compositions, constructions, components, and products without departing from the spirit and scope of this invention. It is intended that all such embodiments be covered by the appended claims.

We claim:

1. A golf ball, comprising:
i) a core assembly, the core assembly comprising:
a) an inner core comprising a thermoset or thermoplastic composition; the inner core having an inner core diameter (ICD) in the range of about 1.2 to about 1.5 inches and an outer surface hardness (H_{inner core surface}), a center hardness (H_{inner core center}), an inner core volume (ICV), and an inner core compression (ICC); and
b) an outer core layer comprising a thermoset or thermoplastic composition, the outer core layer being disposed about the inner core and having a thickness in the range of about 0.05 to about 0.2 inches such that the total core assembly has a total core diameter (TCD) of between about 1.5 to about 1.6 inches, the outer core having an outer surface hardness (H_{outer surface of OC}), a midpoint hardness (H_{midpoint of OC}), an outer core volume (OCV), and a total core compression (TCC),
wherein ICV is greater than OCV and the core assembly has a Core Profile of about 1.8 or greater, wherein:
$$\frac{Inner Core Diameter}{Total Core Diameter} \times \frac{Total Core Compression}{Inner Core Compression} = Core Profile ;$$
and
ii) a cover having at least one layer.

2. The golf ball of claim 1, wherein the core profile is greater than 2.0.

3. The golf ball of claim 1, wherein the core profile is greater than 3.0.

4. The golf ball of claim 1, wherein the OCV has a value less than or equal to the value, X, calculated according to the Equation: (0.9)(ICV)=X.

5. The golf ball of claim 1, wherein the TCC has a value greater than or equal to the value, Y, calculated according to the equation: (2.0)(ICC)=Y.

6. The golf ball of claim 1, wherein the inner core and outer core each comprises a rubber composition.

7. The golf ball of claim 6, wherein the rubber is selected from the group consisting of polybutadiene, polyisoprene, ethylene-propylene, ethylene-propylene-diene, styrene-butadiene, and, polyalkenamer rubbers, and mixtures thereof.

8. The golf ball of claim 6, wherein the H_{inner core surface} is greater than the H_{inner core center} to provide a positive hardness gradient across the inner core; and the H_{outer surface of OC} is greater than the H_{midpoint of OC} to provide a positive hardness gradient across the outer core.

9. The golf ball of claim 8, wherein the H_{outer surface of OC} is greater than the H_{inner core center} to provide a positive hardness gradient across the total core assembly.

10. The golf ball of claim 9, wherein the positive hardness gradient across the total core assembly is in the range of about 15 to about 30.

11. The golf ball of claim 1, wherein the inner core comprises at least about 60% of the total volume of the total core assembly.

12. The golf ball of claim 1, wherein the inner core comprises at least about 70% of the total volume of the total core assembly.

13. The golf ball of claim 1, wherein the inner core has a diameter of about 1.39 inches and the total core assembly has a diameter of about 1.55 inches.

14. The golf ball of claim 1, wherein the inner core has a diameter of about 1.25 inches and the total core assembly has a diameter of about 1.55 inches.

15. The golf ball of claim 1, wherein the inner core has a compression in the range of about 20 to about 50 and the total core assembly has a compression in the range of about 60 to about 110.

16. The golf ball of claim 1, wherein the cover is single-layered and comprises an ethylene acid copolymer containing acid groups such that less than 70% of the acid groups are neutralized.

17. The golf ball of claim 16, wherein the cover comprises a blend of a sodium neutralized ethylene acid copolymer and a lithium neutralized ethylene acid copolymer.

18. The golf ball of claim 1, wherein the cover has an inner cover layer and an outer cover layer; and the inner cover layer comprises an ethylene acid copolymer containing acid groups such that less than 70% of the acid groups are neutralized; and the outer cover layer comprises a polymer selected from the group consisting of polyurethanes, polyureas, polyurethane-urea hybrids, and copolymers and blends thereof.

19. The golf ball of claim 18, wherein the outer cover comprises a thermoplastic polyurethane.

20. The golf ball of claim 18, wherein the outer cover comprises a thermoset polyurethane.
